(19) United States
(12) Patent Application Publication
(10) Pub. No.: US 2021/0060472 A1
(43) Pub. Date: Mar. 4, 2021

(54) FLOW OPTIMIZED FILTER

(71) Applicant: Indufil BV, Zevenaar (NL)

(72) Inventors: Jasper Oranje, Soest (NL); Björn Benner, 's-Heerenberg (NL); Jan Janssen, Gendringen (NL); Tim van der Linde, Veenendaal (NL)

(21) Appl. No.: 17/005,730

(22) Filed: Aug. 28, 2020

Related U.S. Application Data
(60) Provisional application No. 62/894,088, filed on Aug. 30, 2019.

(30) Foreign Application Priority Data
Nov. 21, 2019 (GB) 1917002.6

(51) Int. Cl. B01D 46/00; B01D 46/24

(52) U.S. Cl. CPC B01D 46/0043; B01D 2271/02; B01D 46/2403

(57) ABSTRACT

A gas filtration system includes an inlet to allow gas to enter the system, an outlet through which gas leaves the system, and a filter that includes a filter media that defines a hollow inner region into which gas enters as it flows from the inlet to the outlet. The system also includes a flow straightener disposed between the inlet and the hollow inner region such that a flow path of the gas passes through the flow straightener before it enters the hollow inner region. The flow straightener can be in the filter or upstream of it.

### CROSS REFERENCE TO RELATED APPLICATIONS

This application claims the benefit of an earlier filing date from U.S. Provisional Application Ser. No. 62/894,088 filed Aug. 30, 2019 and United Kingdom Application No. 1917002.6 filed Nov. 21, 2019, the entire disclosure of which is incorporated herein by reference.

### BACKGROUND

Exemplary embodiments pertain to the art of filters and, in particular, to filters for use a gas such a fuel gas. The movement and processing of gases, it is often necessary to filter or otherwise clear contaminants from the gas. The contaminants can be liquids or solids, both of which need to be removed.

The uses of filters are many. In one example, to move natural gas or other centrifugal compressors use a rotating disk or impeller contained in a housing to increase the pressure of a process gas. The rotation of the disk/impeller is provided by a rotating shaft that is driven by an external motor. The shaft can be mated to the rotor of the compressor that carries the disk/impeller. Dry gas seals surround the rotor at or near where the rotor enters housing to form a seal that prevents the process gas from escaping at that location. To correctly operate, such seals need to be provided with clean, non-contaminated gas and filters are used to help ensure the quality of the gas.

In the dry gas seal situation as well as in other situations, to reduce the or eliminate the fluid/contaminants a knock-out filter can be provided to separate liquids from the gas.

Such filters typically include an outer housing with an inlet through which gas is received and directed through a filter media.

### BRIEF DESCRIPTION

Disclosed are a gas filtration system, a filter and a method of filtering a gas. The disclosed embodiments can be used in any situation where a gas is to be filtered. One example is filtering a gas for use in a dry gas seal. Other examples include filtering a gas in any hydrocarbon transportation or refining process.

In one embodiment, a gas filtration system is disclosed. The system includes an inlet to allow gas to enter the system, an outlet through which gas leaves the system, and a filter that includes a filter media that defines a hollow inner region into which gas enters as it flows from the inlet to the outlet. The system also includes a flow straightener disposed between the inlet and the hollow inner region such that a flow path of the gas passes through the flow straightener before it enters the hollow inner region.

In a system of any prior embodiment, the system can further include an adapter is disposed between the inlet and the filter, the adapter including mating elements that mate with the filter.

In a system of any prior embodiment, the flow straightener is located in the adapter.

In a system of any prior embodiment, the flow straightener is located in the filter.

In a system of any prior embodiment, the flow straightener includes an outer periphery and a flow straightening region surrounded by the outer periphery. The flow straightening region can include a plurality of flow straightening passages formed there through in one embodiment.

In a system of any prior embodiment, the plurality of flow straightening passages are honeycomb shaped.

In a system of any prior embodiment, the flow straightening region has a diameter d and a thickness t and t=0.12d.

In a system of any prior embodiment, the outer periphery has a height and the flow straightening region has thickness that is the same as the height.

In a system of any prior embodiment, the outer periphery has a height and the flow straightening region has thickness that is less than the height.

In a system of any prior embodiment, the hollow inner region has a length (L) and the hollow inner region has a diameter (D) and a ratio of L to D (L/D) is less than 5.

In a system of any prior embodiment, ratio of L to D (L/D) is between 4.2 and 4.6.

In one embodiment, a gas filter for use in a gas filtration system is disclosed. The filter includes filter media that defines a hollow inner region into which gas enters as it flows from an inlet to an outlet of the system and a flow straightener disposed such that a flow path of the gas passes through the flow straightener before it enters the hollow inner region.

In a filter of any prior embodiment, the flow straightener includes: an outer periphery and a flow straightening region surrounded by the outer periphery, the flow straightening region including a plurality of flow straightening passages formed there through.

In a filter of any prior embodiment, the plurality of flow straightening passages are honeycomb shaped.

In a filter of any prior embodiment, the flow straightening region has a thickness t defined between two opposing sides of the flow straightening region. The two sides define parallel planes in one embodiment.

In a filter of any prior embodiment, the flow straightening region has a diameter d and a thickness t and t=0.12d.

In a filter of any prior embodiment, the outer periphery has a height and the flow straightening region has thickness t that is the same as the height.

In a filter of any prior embodiment, the outer periphery has a height and the flow straightening region has thickness that is less than the height.

In a filter of any prior embodiment, wherein the hollow inner region has length (L) and the hollow inner region has a diameter (D) and a ratio of L to D (L/D) is less than 5.

In a filter of any prior embodiment, wherein ratio of L to D (L/D) is between 4.2 and 4.6.

Also disclosed is a method of filtering gas. The method includes: providing gas to an inlet of a gas filtration system to allow gas to enter the system; directing the gas to a filter that includes a filter media that defines a hollow inner region; passing the gas through a flow straightener disposed between the inlet an the hollow inner region before the flow enters the hollow inner region of the filter; and providing gas that has passed through the filter to the gas sealing device.

In any of the above embodiments, the filter/adapter has included a flow straightener. The straightener any prior embodiment can have a thickness t defined between two opposing sides of the flow straightening region of straightener. The two sides can be substantially flat and define parallel planes. These two parallel sides are spaced such (e.g., thickness t) to impart a desired amount of “straightening.” In one embodiment, t is (0.12)d. Of course, other ratios could exist. For example, t can be less than 0.2d. In another embodiment, the 0.05d<t<0.2d

### BRIEF DESCRIPTION OF THE DRAWINGS

The following descriptions should not be considered limiting in any way. With reference to the accompanying drawings, like elements are numbered alike:

FIG. 1 shows an example of a gas filtration system that can include one or more embodiments;

FIG. 2 is a perspective view of an adapter according to one embodiment;

FIG. 3A shows an example vortex flow that can be created if embodiments of the present invention are not implemented;

FIG. 3B shows an example vortex flow that can be created if embodiments of the present invention are implemented;

FIG. 4A is top view of a flow straightener according to one embodiment;

FIG. 4B is a cut-away perspective view of a flow straightener according to one embodiment;

FIG. 4C shows on example of the flow passages that may be implemented in a flow straightener according to one embodiment;

FIG. 4D is a perspective view of a flow straightener according to one embodiment;

FIG. 4E is an enlarged view of a portion of the flow straightener of FIG. 4D;

FIG. 5 is a cross section of an example of a filter according to one embodiment; and

FIGS. 6A and 6B show trapezoidal holes that can be implement in filters of some embodiments;

FIG. 7 shows variations in spacing between round holes that can be applied to any type of holes disclosed herein; and

FIGS. 8 and 9 show filters with varying arrangements for round and trapezoidal shaped holes, respectively.

### DETAILED DESCRIPTION

A detailed description of one or more embodiments of the disclosed apparatus and method are presented herein by way of exemplification and not limitation with reference to the Figures.

Many prior filters assemblies include one or more filter housings and generally work well for their intended purposes Each housing surrounds a filter element that removes liquids from a gas. These filter elements can include a hollow inner region surround by a filter medium that removes the liquid. However, due to need for one or more turns in a gas flow path (e.g., one or more 90° turns) before it enters the filter element and passes through the filter media. The turns (e.g., flow diversions) can lead to the creation of vortexes and local regions of turbulence can be created in the gas. Such vortexes and local regions of turbulence can result in the unequal distribution of the gas in the filter element and over the filter media. The unequal flows can lead to pressure loss over the filter element and also impacts the coalescing efficiency and increases the risk of re-entrainment of liquid droplets downstream of the filter.

Embodiments disclosed herein may overcome one or more of the above noted issues. In one embodiment, a flow optimized design of the filter element and the path into the filter (in particular, into the hollow inner region of the filter element) are provided that can improve the flow distribution in the filter element. This will not only reduce the total pressure loss over the filter element, it also improves the coalescing efficiency and reduces the risk of re-entrainment of liquid droplets into the downstream gas stream.

One implement that can improve the flow is straightener. The flow straightener is part of and located at a filter element inlet in one embodiment. As further discussed below, the filter element can also be located in an adapter that mates with the filter element in another embodiment.

Further or alternative improvements may be obtained by providing a filter media having a length/diameter ratio lower than typically utilized in the industry. In particular, the ratio can be between 4.2 to 4.6 and in particular about 4.4 or 4.5.

Regardless of the ratio, in general, by including the flow straighteners disclosed herein, the flow will be distributed such that it has a more equal distribution of face velocity over the surface area of a filter media of the filter.

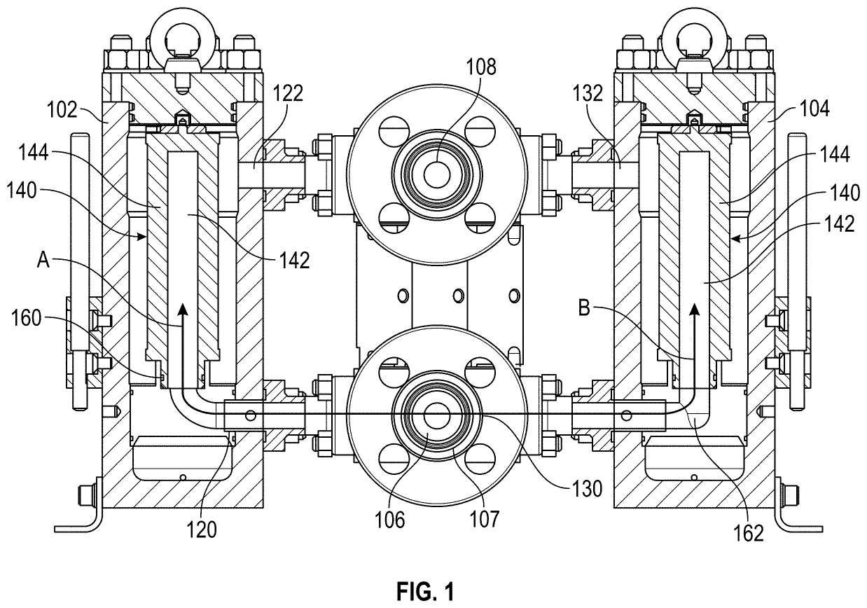

To further illustrate embodiments gas filtration system (or filter assembly) 100 is shown in FIG. 1. The filter assembly 100 includes two filter housings 102, 104. Embodiments herein can include a filter assembly that includes a single filter housing or more than two filter housings. When two filter housings are provided, the filter assembly 100 may be referred to as duplex filter assembly. Regardless of the configuration, the filter assembly includes an inlet 106 and an outlet 108. In normal operation, gas enters the filter assembly 100 at the inlet 106 and leaves it at the outlet 108. As the gas passes from the inlet 106 to the outlet 108 it will pass through at least one of the filter housings 102, 104. Typically, the gas will only pass through one of the filter housings 102, 104 during operation. Of course, while passing through assembly 100, gas will pass through the filter media of any filter in the filter housings 102, 104.

While not specifically illustrated in FIG. 1, the filter assembly 100 can include a transfer valve 107 that selects which filter housing 102, 104 the gas passes through. Having two filter housings 102, 104 can allow for uninterrupted operation of the filter assembly 100 when a filter element is being replace in one of the filter housings. That is, when a filter element is being replaced in filter housing 102 (also referred to as first filter housing 102), the gas will pass through the other filter housing 104 (also referred to as second filter housing 104).

The first filter housing 102 includes a first filter housing inlet 120 and a first filter housing outlet 122. Similarly, the second filter housing 104 includes a second filter housing inlet 130 and a second filter housing outlet 132. The first and second filter housing inlets 120, 130 are in fluid communication with the inlet 106 of the filter assembly 100. As discussed above, a diverter valve will direct the gas to one of the first and second filter housing inlets 120, 130 during operation. The first and second filter housing outlets 122, 132 are in fluid communication with the outlet 108 of the filter assembly 100.

Each of the filter housings 102, 104 includes a filter element 140 disposed therein. In operation, gas that flows from the inlet 106 to the outlet 108 will pass through one of the filter elements.

The filter element 140 includes a hollow inner region 142. Each filter housing 102, 104 includes an adapter that fluidly connects a respective filter housing inlet 120, 130 to a filter element 140 contained therein. As shown, the first filter housing 102 includes first adapter 160 and the second filter housing 104 includes a second adapter 162. As illustrated, the first and second adapters 160, 162 are configured different from each other. In any embodiment herein that includes two filter housings, the first and second adapters can be of the same type. That is, in one embodiment, both the first and second filter housings 102, 104 can include the first adapter 160 or in another both can include the second adapter 162.

As generally shown in FIG. 1, the adapters will cause flows A/B entering them to change direction by 90°. The sharper the turn, the more vorticity that can be created. Thus, in one embodiment, the first adapter 160 will be selected as it has a more gradual turn.

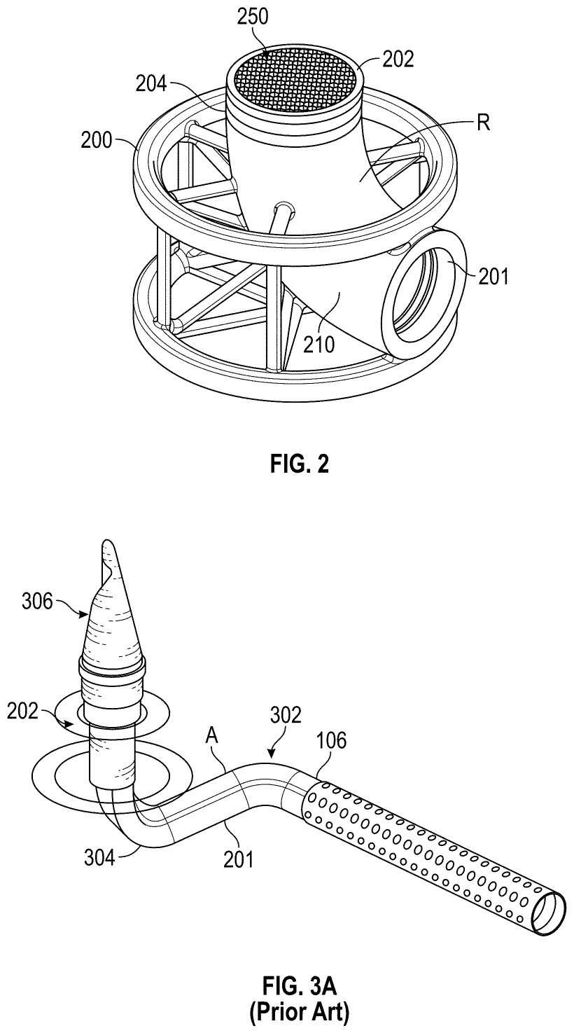

FIG. 2 shows an example of an adapter 200 that can be either the first or second adapter 160, 162. The illustrated adapter 200 more closely resembles that of the first adapter 160 in FIG. 1 but the teachings related to the adapter 200 can be applied either the first or second adapter 160, 162.

The adapter 200 includes an adapter inlet 201 and an adapter outlet 202. Threads 204 or other mating elements may be provided at or near the adapter outlet 202 to allow for connection to 142 a filter element 140. As shown, the adapter 200 includes a flow straightener 250 disposed on the adapter outlet 202. The flow straightener is discussed further below but it shall be understood that while shown in the adapter 200, the flow straightener 250 could be part of or disposed in the filter element 140 (FIG. 1).

The adapter 200 includes a curved region 210 between the adapter inlet 201 and the adapter outlet 202 that has a radius of curvature R. The radius can be selected to help reduce the vortex flow at the adapter outlet 202. The adapter 200 be formed by different processes, including an additive manufacturing process or casting process.

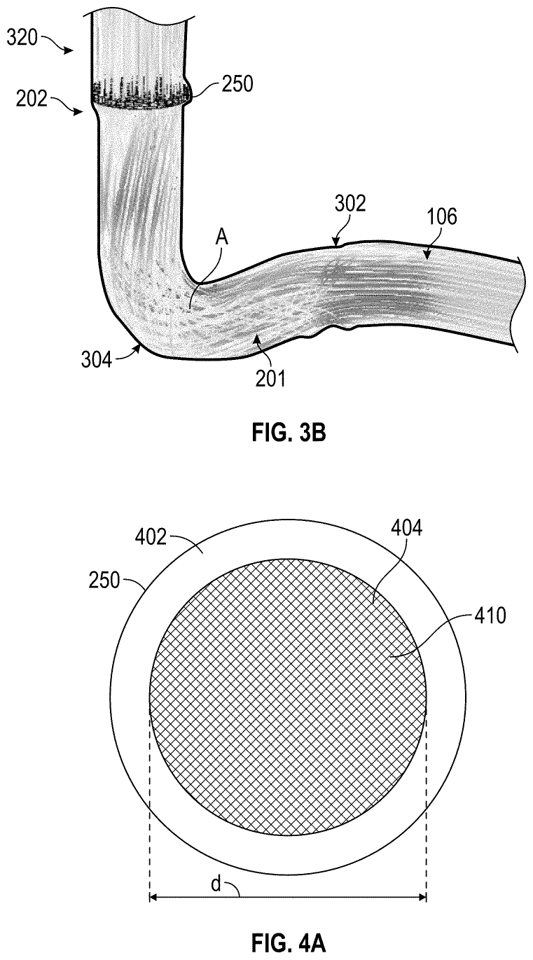

FIG. 3A shows an example of the gas flow A as it passes though the inlet 106, into the adapter inlet 201 and through the adapter outlet 202. The locations of the particular elements refers to FIGS. 1 and 2 and is pointed to by arrows for clarity. After passing through inlet 106, the flow A makes two angled turns (e.g., 90°) as indicated at locations 302, 304 before leaving the adapter outlet 202. The turns can result in the creation of region of vortex flow 306. As discussed above, such a flow can reduce the effectiveness of the filter element 140 (FIG. 1).

Contrast FIG. 3A with FIG. 3B which shows the flow A leaving the adapter outlet 202 after passing through the flow straightener 250. As illustrated, it shall be appreciated that as the flow A leaves the outlet 202 it passes completely through the flow straightener. The flow straightener can either be in the adapter 200 or in the filter element 140 (FIG. 1). In particular, it is noted that the flow as itleaves the adapter 200 has less of a conical or vortex shape as indicated by reference numeral 320.

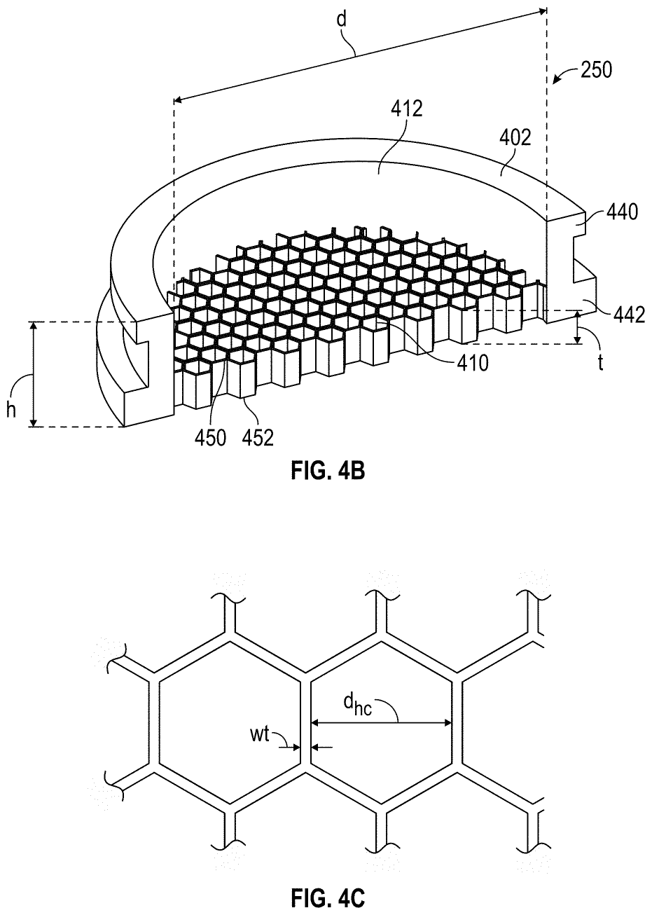

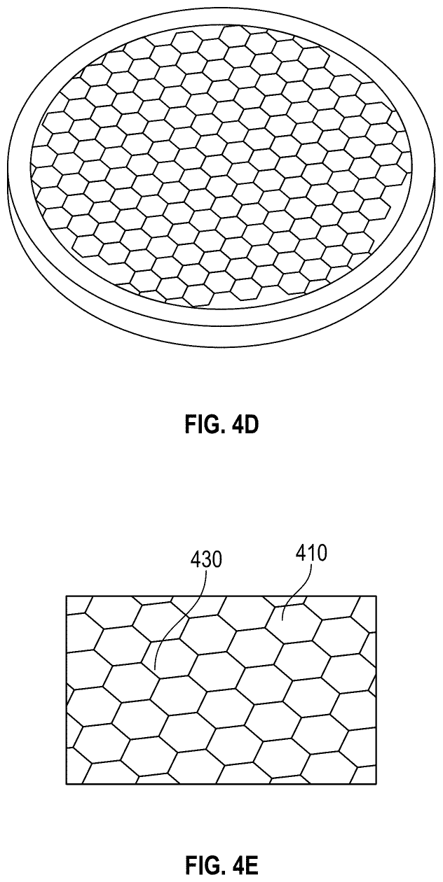

FIG. 4A shows a top-view of a flow straightener 250 that can be included in the filter assembly 100 of FIG. 1. The flow straightener 250 is in the filter element 140 in one embodiment and in at least one of the first and second adapters 160, 162 in another.

Regardless of the location, the flow straightener 250 includes an outer periphery 402. In one embodiment, the outer periphery 402 is round but other shapes are contemplated. As shown, the outer periphery 402 surrounds a straightening region 404 that includes a plurality of flow passages formed therein and may be referred to as flow straightening passages. The passages 410 generally includes hollow flow regions bounded by separating walls. As gas flows the through the flow straightener 250 the swirling vortex pattern in the gas is reduced or eliminated. That is, the flow A can be transformed from that shown in FIG. 3A to that shown in FIG. 3B.

The outer periphery 402 includes an inner wall 412 that defines a diameter d of the defines a diameter d of the flow straightening region 404 of the flow straightener 250.

As illustrated in FIG. 4B, the flow straightening region 404 of the flow straightener 250 has a thickness t. In a filter of any embodiment, the thickness t defined between two opposing sides 450, 452 of the flow straightening region 404. The two sides 450, 452 are substantially flat and define parallel planes in one embodiment. These two parallel sides are spaced such (e.g., thickness t) to impart a desired amount of “straightening.” This is different than, for example, an interwoven wire mesh that will have non-flat sides

In one embodiment, t is (0.12)d. Of course, other ratios could exist. For example, t can be less than 0.2d. In another embodiment, the 0.05d<t<0.2d

In a particular embodiment, d is 31.5 mm and t is 3.7 mm in one embodiment.

In FIG. 4B the passages 410 are honeycomb shaped. As shown in FIG. 4C, the honeycomb shaped passage 410 can have a distance d_{hc} between opposing sides. d_{hc} is about 2 mm in one embodiment. Each honeycomb shaped passage 410 can have a wall thickness wt. In one embodiment, wt is between 0.15 mm and 0.30 mm. In one embodiment, wt is about 0.25 mm.

In FIG. 4b the outer periphery 402 includes both a height h and first and outward projections 440, 442. The height h can be limited such that it is the same as the thickness t of the straightening region 404 of the flow straightener 250 in one embodiment. An example of such flow straightener 250 is shown in FIG. 4D. From the embodiment shown in 4D it shall be understood that either one or both of the outward projections are optional in any embodiment.

In an alternative embodiment, and as shown in FIG. 4E, rather than having a honeycomb pattern, the straightening passages 410 can be circular. In this embodiment, the thickness t can have the same or similar relationship to the diameter as described above. In a particular embodiment, t is 3.7 mm. Walls 430 between these passages have largest thickness of about 0.1 mm in one embodiment.

Regardless of how formed, as discussed above, the flow straightener 250 can be located in either of the adapters 160, 162 or in the filter element 140.

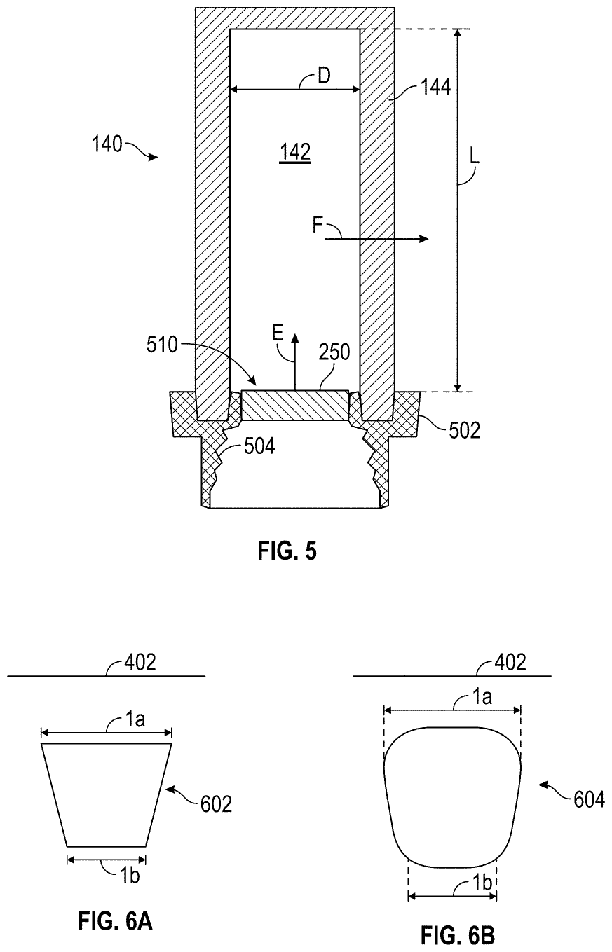

FIG. 5 shows an example of a filter element 140 according to one embodiment. The filter element 140 includes a mating region 502 that includes one or more mating elements 504 to mate with the adapters previously described. As shown, the mating elements 504 are threads. In one embodiment, the mating region is formed of metal.

With reference to both FIGS. 1 and 5, the filter element 140 includes a filter media 144 that can filter at least fluids from processes gas. The filter media 144 defines the hollow inner region 142 into which gas enters before passing outwardly through the filter media 144 (as indicated by arrows E and F, respectively).

In this example, the filter element 140 includes the flow straightener 250. The flow straightener 250 can be any of the prior disclosed flow straighteners or modifications thereof. The flow straightener 250 is arranged in the filter element 140 so that any gas entering the hollow inner region 142 first passes through the flow straightener 250. In particular, the flow straightener 250 is disposed “upstream” of hollow inner region 142 such that gas passes through the flow straightener 250 before it can enter the hollow inner region or pass through the filter media 144 during operation. As discussed above, operating in such a manner improves flow through the filter element 140 (i.e., in the hollow inner region 142). This can result in improved flow distribution in and through the filter media 144 in all regions, not just near the inlet 510 to the hollow inner region 142 (also referred to herein as the filter element inlet).

The hollow inner region 142 includes a diameter D and length L. A ratio of these two values (L/D) is below 5 and, in particular, between 4 and 5 in one embodiment. In another, it is between 4.2 and 4.6. Such a ratio has been modeled to have a more even flow distribution over the length L of the hollow inner region. This is different than prior art approaches where a small diameter and larger relative length are used to increase surface area. That is, in the prior art, L/D was typically much larger than 5.

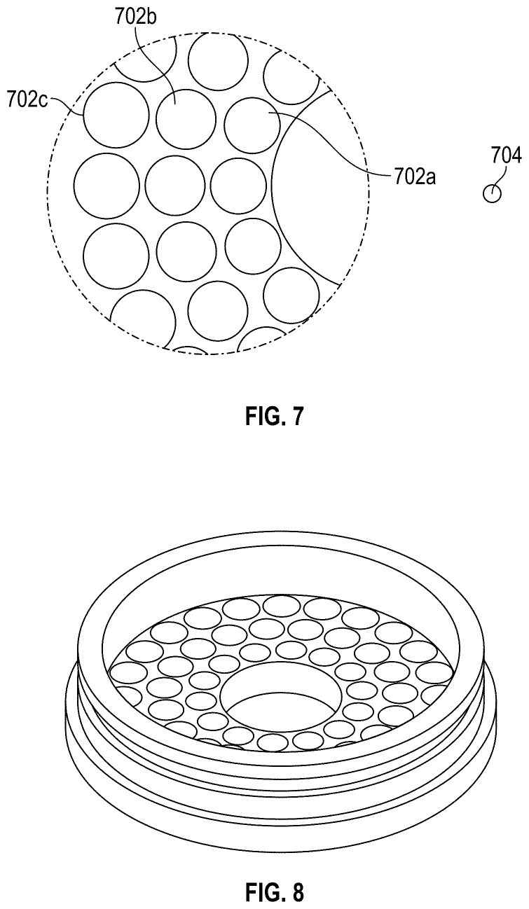

Above disclosed are different types of filter configurations having honeycomb or circular holes. These shapes are not the only possible shapes. For example, the holes could be any geometric shape including, but not limited to, a trapezoid hole 602 as shown in FIG. 6A. Relatedly, the hole could be a trapezoidal hole 604 that includes rounded corner as in FIG. 6B. The holes 602, 604 both have a long side 602a, 604a and a short side 602b, 604b. The long and shorts sides have lenglth la/lb, respectively in each figure. When formed into a filter, the long sides 602a, 604a are closer to outer periphery 402 than the short sides 602b, 604b.

It should further be understood, that the size of the holes in any embodiment can increase as the holes move further out from a center of flow straightening filter 250. Such is shown in FIG. 7 where each successive radially outward hole (e,g., 702a, 702b, 702c) has a larger diameter (da, db, dc). In FIG. 7 the outer periphery 402 is on the left of the figure and the center of filer is generally shown by centerpoint 704. Also, the distance between successive radial outward holes 702 can be constant, decrease, or increase. In FIG. 7, the spacing is constant but this is not meant as limiting. The same spacing and sizing adjustments can apply to all types of holes described herein. In FIG. 7 some specific dimensions are shown these are illustrative only.

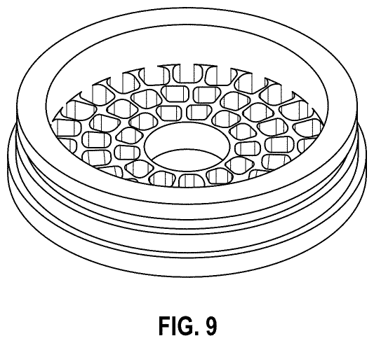

FIGS. 8 and 9 show some of these arrangement for round and trapezoidal shaped holes, respectively.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A gas filtration system comprising:
an inlet to allow gas to enter the system;
an outlet through which gas leaves the system;
a filter that includes a filter media that defines a hollow inner region into which gas enters as it flows from the inlet to the outlet; and
a flow straightener disposed between the inlet and the hollow inner region such that a flow path of the gas passes through the flow straightener before it enters the hollow inner region, wherein the flow straightener includes:
an outer periphery; and
a flow straightening region surrounded by the outer periphery, the flow straightening region including a plurality of flow straightening passages formed there through;
wherein the outer periphery has a height and the flow straightening region has thickness (t) that is less than the height.

2. The gas filtration system of claim 1, further comprising:
an adapter disposed between the inlet and the filter, the adapter including mating elements that mate with the filter.

3. The gas filtration system of claim 2, wherein the flow straightener is located in the adapter.

4. The gas filtration system of claim 2, wherein the flow straightener is located in the filter.

5. The gas filtration system of claim 1, wherein the plurality of flow straightening passages are honeycomb shaped.

6. The gas filtration system of claim 1, wherein the flow straightening region has a diameter d and t=0.12d.

7. The gas filtration system of claim 1, wherein the flow straightening region has two opposing sides that are substantially planar and parallel to each and separated from one another by the thickness (t) of the flow straightening region.

8. The gas filtration system of claim 1, wherein t is less than 0.2d.

9. The gas filtration system of claim 8, wherein t is greater than 0.05d.

10. The gas filtration system of claim 9, wherein the hollow inner region has a length (L) and the hollow inner region has a diameter (D) and a ratio of L to D (L/D) is less than 5.

11. The gas filtration system of claim 10, wherein ratio of L to D (L/D) is between 4.2 and 4.6.

12. A gas filter for use in a gas filtration system, the filter comprising:
filter media that defines a hollow inner region into which gas enters as it flows from an inlet to an outlet of the system, wherein the hollow inner region has a length (L) and the hollow inner region has a diameter (D) and a ratio of L to D (L/D) is less than 5; and
a flow straightener disposed such that a flow path of the gas passes through the flow straightener before it enters the hollow inner region.

13. The filter of claim 12, wherein the flow straightener includes:
an outer periphery; and
a flow straightening region surrounded by the outer periphery, the flow straightening region including a plurality of flow straightening passages formed there through.

14. The filter of claim 13, wherein the plurality of flow straightening passages are honeycomb shaped.

15. The filter of claim 13, wherein the flow straightening region has a diameter d and a thickness t and t=0.12d.

16. The filter of claim 13, wherein the flow straightening region has two opposing sides that are substantially planar and parallel to each and separated from one another by the thickness (t) of the flow straightening region.

17. The filter of claim 13, wherein t is less than 0.2d.

18. The filter of claim 17, wherein t is greater than 0.05d.

19. The gas filtration system of claim 12, wherein ratio of L to D (L/D) is between 4.2 and 4.6.

20. A method of filtering gas, the method comprising:
providing gas to an inlet of a gas filtration system to allow gas to enter the system;
passing the gas through a flow straightener;
after passing the gas through the flow straighter, directing the gas to inner hollow region of a filter that includes a filter media that defines the hollow inner region;
passing the gas inside the hollow inner region through the filter; and
providing gas that has passed through the filter to the gas sealing device.

21. The method of claim 20, wherein the hollow inner region has a length (L) and the hollow inner region has a diameter (D) and a ratio of L to D (L/D) is less than 5.
